(19) United States
(12) Patent Application Publication
(10) Pub. No.: US 2016/0267217 A1
(43) Pub. Date: Sep. 15, 2016

(54) DISPLAY APPARATUS AND DESIGN METHOD OF SEMICONDUCTOR INTEGRATED CIRCUIT

(71) Applicant: KABUSHIKI KAISHA TOSHIBA, Tokyo (JP)

(72) Inventor: Gaku TAKEMURA, Yokohama Kanagawa (JP)

(73) Assignee: KABUSHIKI KAISHA TOSHIBA, Tokyo (JP)

(21) Appl. No.: 14/844,209

(22) Filed: Sep. 3, 2015

(30) Foreign Application Priority Data
Mar. 10, 2015 (JP) 2015-047650

(51) Int. Cl. G06F 17/50

(52) U.S. Cl. CPC G06F 17/5081; G06F 17/5009

(57) ABSTRACT

According to one embodiment, there is provided a display apparatus including a display unit and a display control unit. The display control unit displays on the display unit a schematic diagram in which symbols of schematic elements are associated with respective information about antenna ratios of the schematic elements based on first information in which the antenna ratios related to plasma damage are associated with identifiers of the schematic elements.

### CROSS-REFERENCE TO RELATED APPLICATIONS

This application is based upon and claims the benefit of priority from Japanese Patent Application No. 2015-047650, filed on Mar. 10, 2015; the entire contents of which are incorporated herein by reference.

### FIELD

Embodiments described herein relate generally to a display apparatus and a design method of a semiconductor integrated circuit.

### BACKGROUND

In designing a semiconductor integrated circuit, the designing of a schematic diagram (circuit diagram) is performed with use of a schematic editor to create schematic data. The designing of a layout pattern according to the schematic data is performed with use of a layout editor to create layout data. Verification of whether the design of the layout pattern coincides with the design of the schematic diagram and verification of whether antenna ratios related to plasma damage satisfy a physical design criterion (antenna design rule check) are performed with use of a verification tool. Then the layout pattern is redesigned according to the verification results with use of the layout editor to create layout data again. Here, it is desired to make the redesigning of the layout pattern efficient.

### BRIEF DESCRIPTION OF THE DRAWINGS

FIG. 1 is a diagram showing design criteria for an antenna ratio in an embodiment;

FIG. 2 is a diagram showing the hardware configuration of a display apparatus according to the embodiment;

FIG. 3 is a data flow diagram showing the operation of the display apparatus according to the embodiment;

FIG. 4 is a chart showing the data structure of second information in the embodiment;

FIG. 5 is a chart showing the data structure of third information in the embodiment;

FIG. 6 is a chart showing the data structure of fourth information in the embodiment;

FIG. 7 is a chart showing the data structure of first information in the embodiment;

FIG. 8 is a diagram showing information displayed on a display unit in the embodiment;

FIG. 9 is a flow chart showing a design method of a semiconductor integrated circuit using the display apparatus according to the embodiment;

FIG. 10 is a flow chart showing a PID-BA process in the embodiment;

FIG. 11 is a data flow diagram showing the operation of a display apparatus according to a modified example of the embodiment;

FIG. 12 is a chart showing the data structure of fifth information in the modified example of the embodiment;

FIG. 13 is a chart showing the data structure of sixth information in the modified example of the embodiment;

FIG. 14 is a chart showing the data structure of seventh information in the modified example of the embodiment;

FIG. 15 is a chart showing the data structure of eighth information in the modified example of the embodiment;

FIG. 16 is a diagram showing information displayed on a display unit in the modified example of the embodiment;

FIG. 17 is a chart showing the data structure of ninth information in the modified example of the embodiment;

FIG. 18 is a graph showing simulation results in another modified example of the embodiment; and

FIG. 19 is a flow chart showing a design method of a semiconductor integrated circuit using a display apparatus according to the other modified example of the embodiment.

### DETAILED DESCRIPTION

In general, according to one embodiment, there is provided a display apparatus including a display unit and a display control unit. The display control unit displays on the display unit a schematic diagram in which symbols of schematic elements are associated with respective information about antenna ratios of the schematic elements based on first information in which the antenna ratios related to plasma damage are associated with identifiers of the schematic elements.

Exemplary embodiments of a display apparatus will be explained below in detail with reference to the accompanying drawings. The present invention is not limited to the following embodiments.

### Embodiment

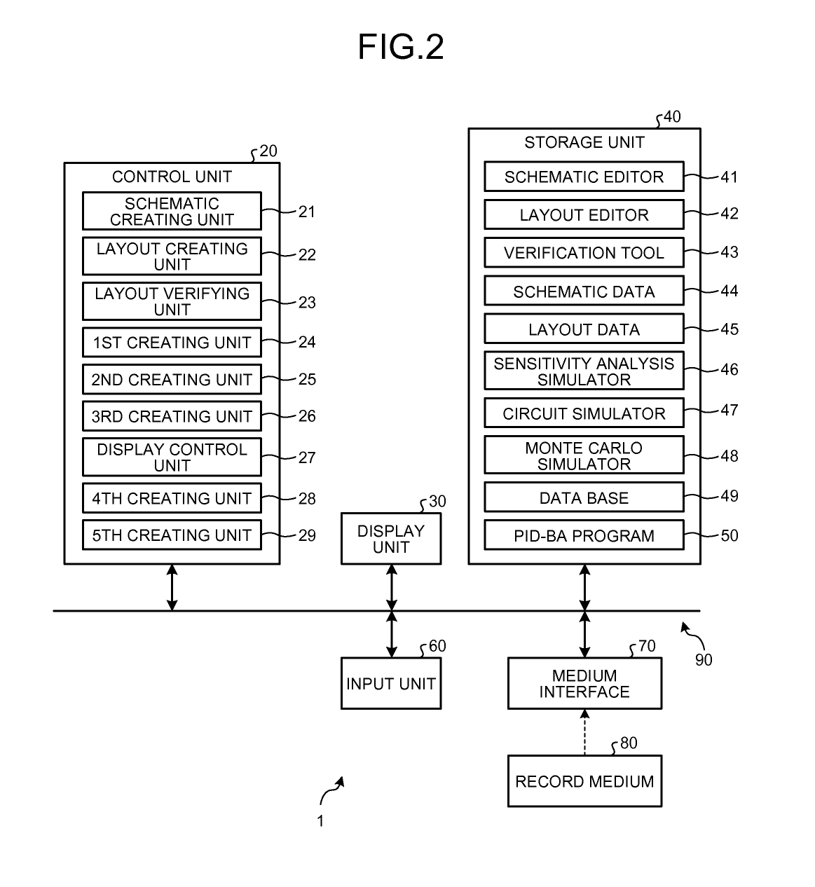

A display apparatus 1 according to the embodiment will be described. The display apparatus 1 is used in designing semiconductor integrated circuits. In designing semiconductor integrated circuits, designing using EDA (Electronic Design Automation) tools is performed. The EDA tools include, for example, a schematic editor 41, a layout editor 42, and a verification tool 43 (see FIG. 2). In designing a semiconductor integrated circuit with use of the EDA tools, the designing of a schematic diagram (circuit diagram) is performed with use of the schematic editor 41 to create schematic data. The designing of a layout pattern according to the schematic data is performed with use of the layout editor 42 to create layout data. Verification of whether the design of the layout pattern coincides with the design of the schematic diagram or verification of whether the design of the layout pattern satisfies physical design criteria (design rules) (design rule check) is performed with use of the verification tool 43. Then the layout pattern is redesigned according to the verification results with use of the layout editor to create layout data again.

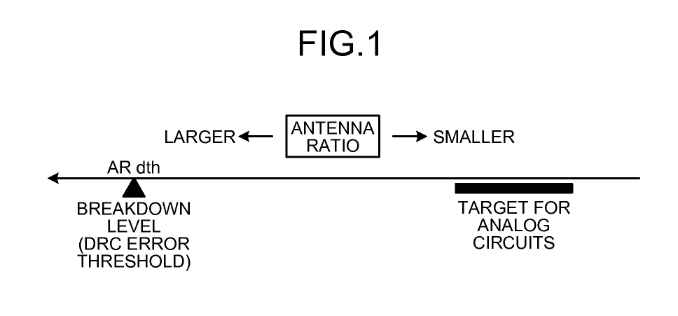

MOS transistors of highly-integrated LSI circuits are subject to damage due to electrostatic charging by plasma etching in a metal line production process. This is called PID (Plasma Induced Damage) or plasma damage. Metal lines are connected to the poly-silicon gates of MOS transistors via gate contacts. In the production process of the contacts, metal lines, and vias, the contacts, metal lines, and vias are electrified, which causes electrostatic breakdown in the gate oxide film of MOS transistors, so that the characteristics of the transistors are affected. There are known several parameters that determine the strength of the PID, and an antenna ratio (AR) is representative of them. The AR is a parameter determining an antenna effect of lines and the like and is expressed by the ratio of the areas of lines and the like (metal lines, vias, and contacts) to the area of the poly-silicon gate. As to the AR, layout data is verified (examined) using the verification tool 43, so that the layout is designed such that electrostatic breakdown will not occur. That is, the verification tool 43 outputs an error file in which identifiers of layout elements whose antenna ratios exceed an error threshold (a DRC error threshold shown in FIG. 1) are associated with coordinate values of the layout elements. This is called an antenna design rule check. Then, referring to the error file, the layout pattern is redesigned with the layout editor 42.

For the PID, especially the AR, a design criterion for preventing breakdown exists as mentioned previously. However, even if the design criterion is satisfied, that is, the AR is below the design criterion, it is not that there is no influence on the circuit. This design criterion is a criterion set for MOS transistors breaking down, and for analog circuits, with the AR below this criterion, a bad influence on the circuit appears. With the AR below the breakdown criterion, a bad influence on MOS transistors such as increase in Vth or increase in variation in Vth appears. In differential circuits, current mirror circuits, and the like, difference in Vth between MOS transistors for which pair symmetry is important is not preferable. Thus, for MOS transistors for which Vth pair symmetry is important, such layout design is desired that the AR of each transistor is the same. Although it is mentioned above that the AR should be the same, that is, relative values of the AR are referred to, it is also desirable that the absolute values of the AR are low for analog circuits.

As above, it is desirable that the AR is the same for MOS transistors for which Vth pair symmetry is important. This is usually naturally (maybe not exact) achieved by drawing MOS transistors and metal lines connected thereto in symmetric shapes, but if a restriction on the chip area is severe, or so on, true shape symmetry may not be achieved. Further, because making the AR the same needs symmetry involving the metal layer configuration being used as well as the shape symmetry of metal lines, a visual drawing check may result in insufficient verification. Further, for DC circuits (circuits outputting a direct-current voltage) and the like, shape symmetry is not necessarily needed, and the AR being the same in value is enough, but in this case, a visual drawing check can hardly be an effective verification means. Further, for transistors for which pair symmetry is important, because it takes time to verify correspondences between a circuit diagram and a layout, it is difficult to find out the antenna ratio of which layout element is not the same. Thus, it is likely to take time to identify which layout element in the layout pattern is to be redesigned so that the characteristics of the analog circuit satisfy required specifications, and redesigning the layout pattern is likely to be inefficient.

Further, in analog circuits, the degree of contribution to the characteristics of the entire circuit of transistors of interest may be different for each transistor, and the degree of importance of redesigning so that the characteristics of the analog circuit satisfy required specifications may be different for each transistor. The degree of importance of redesigning is difficult to intuitively realize from the layout pattern because it needs to be studied considering the circuit configuration. Hence, it is likely to take time to identify which layout element in the layout pattern is to be redesigned so that the characteristics of the analog circuit satisfy required specifications, and thus redesigning the layout pattern is likely to be inefficient.

For the above reasons, it is desired to establish a mechanism to verify the symmetry of the AR automatically or semi-automatically. That is, automatically extracting the AR's from a layout and visualizing them for all the MOS transistors may lead to improvement in the performance of analog circuits, a reduction in variation, and improvement in yield.

Accordingly, in the present embodiment, by displaying a schematic diagram in which the symbols and respective information about antenna ratios of schematic elements are associated with each other on a display unit 30 of the display apparatus 1 and visualizing the antenna ratios on the schematic diagram, it is made easy to identify layout elements to be redesigned, and it is made efficient to redesign the layout pattern. Hereinafter, the process for visualizing antenna ratios on a schematic diagram is called a PID-BA (Plasma Induced Damage-Back Annotation) process.

Specifically, the display apparatus 1 has the configuration shown in FIG. 2. FIG. 2 is a diagram showing the hardware configuration of the display apparatus 1.

The display apparatus 1 comprises a bus 90, a control unit 20, a display unit 30, a storage unit 40, an input unit 60, and a medium interface 70.

The control unit 20, display unit 30, storage unit 40, input unit 60, and medium interface 70 are connected to each other via the bus 90. The medium interface 70 is configured such that a record medium 80 can be connected thereto.

The display unit 30 is, for example, a display device such as a CRT display or a liquid crystal display. The storage unit 40 is, for example, a memory, a hard disk, or the like. The input unit 60 is, for example, a key board, a mouse, or the like. The medium interface 70 is, for example, a flexible disk drive, a CD-ROM drive, a USB interface, or the like. The record medium 80 is a flexible disk, a CD-ROM, a USB memory, or the like.

In the storage unit 40, the schematic editor 41, the layout editor 42, the verification tool 43, schematic data 44, layout data 45, a data base 49, and a PID-BA program 50 are stored.

The schematic editor 41 is an EDA (Electronic Design Automation) tool for performing design of a schematic (circuit diagram) level in designing integrated circuits or so on. The layout editor 42 is an EDA tool for performing design of a layout level in designing integrated circuits or so on. The verification tool 43 is an EDA tool for performing verification of whether the design of a layout pattern coincides with the design of a schematic diagram (LVS: Layout versus schematic) or verification of whether the design of the layout pattern satisfies physical design criteria (design rules) (DRC: Design rule check) in designing integrated circuits or so on. The schematic data 44 is data of a schematic diagram (circuit diagram) created by the schematic editor 41. The layout data 45 is data of a layout pattern created by the layout editor 42. The data base 49 is a data base including the results of verifying whether the design of a layout pattern coincides with the design of a schematic diagram (LVS). The PID-BA program 50 is a program for performing the PID-BA process (a process for visualizing the antenna ratios on a schematic diagram).

The control unit 20 is, for example, a CPU, GPU, DSP, microcomputer, or the like and includes a cache memory for temporary storage. The control unit 20 further includes a schematic creating unit 21, a layout creating unit 22, a layout verifying unit 23, a first creating unit 24, a second creating unit 25, a third creating unit 26, and a display control unit 27.

The schematic creating unit 21 is functionally realized in the control unit 20 by executing the schematic editor 41. For example, the schematic creating unit 21 calls out the symbols of schematic elements from a predetermined library and places them on a schematic diagram to create schematic data 44. The schematic creating unit 21 stores the schematic data 44 into the storage unit 40.

The layout creating unit 22 is functionally realized in the control unit 20 by executing the layout editor 42. The layout creating unit 22 places objects of layout elements on a layout pattern according to the schematic data 44 created by the schematic creating unit 21 to create layout data 45. The layout creating unit 22 stores the layout data 45 into the storage unit 40.

The layout verifying unit 23 is functionally realized in the control unit 20 by executing the verification tool 43. The layout verifying unit 23 verifies whether the design of a layout pattern coincides with the design of a schematic diagram (LVS) or verifies whether the design of the layout pattern satisfies physical design criteria (design rules) (DRC).

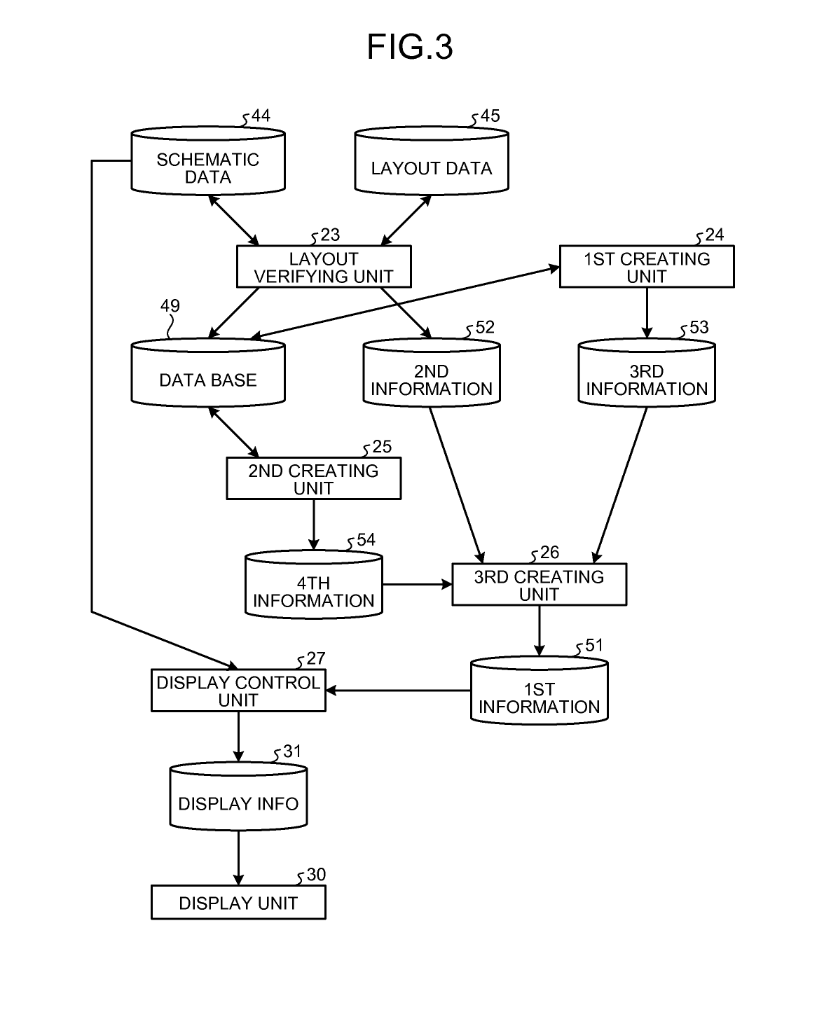

For example, as shown in FIG. 3, the layout verifying unit 23 reads out the layout data 45 and the schematic data 44 from the storage unit 40. The layout verifying unit 23 verifies to what degree the layout data 45 and the schematic data 44 coincide to create a data base 49 concerning the verifying results. FIG. 3 is a data flow diagram showing the operation of the display apparatus 1.

In the data base 49, correspondence information between coordinate positions on the layout pattern and the identifiers of layout elements (first correspondence information) and correspondence information between the identifiers of the layout elements and the identifiers of schematic elements (second correspondence information) are separately, independently managed. The data base 49 does not have a function to directly associate correspondence information between coordinate positions on the layout pattern and the identifiers of layout elements (first correspondence information) with correspondence information between the identifiers of the layout elements and the identifiers of schematic elements (second correspondence information). A typical data base does not have a function to directly associate the first correspondence information with the second correspondence information, but also where a data base having a function to directly associate the first correspondence information with the second correspondence information is used, the same configuration can be applied.

It should be noted that the identifiers of schematic elements are identifiers which a user has given to transistors via the schematic editor 41, whereas the identifiers of layout elements are identifiers which the verification tool 43 has arbitrarily determined and given to the layout elements (transistors). Hence, it is difficult to realize to which schematic elements the identifiers of the layout elements correspond by seeing the identifiers of the layout elements.

The layout verifying unit 23 extracts the antenna ratio for each layout element from the layout data 45 to create second information 52. The second information 52 is information in which the antenna ratios are associated with positions on the layout pattern. Extracting the antenna ratio for each layout element can use the function of the verification tool 43 to output an error file for layout elements whose antenna ratios exceed an error threshold. For example, if “0” is set as the error threshold in the verification tool 43, then an error file (file including information in which the antenna ratios are associated with positions on the layout pattern) for all the layout elements can be outputted, so that this error file can be used as the second information 52.

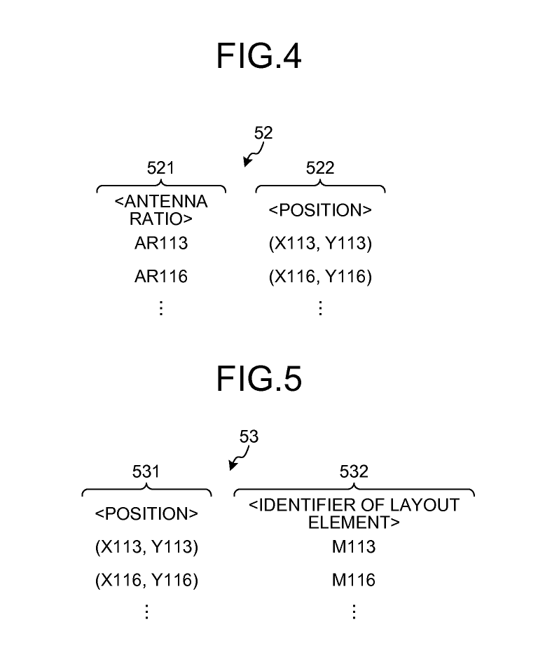

The second information 52 is information in which the antenna ratios are associated with positions on the layout pattern as shown in FIG. 4. FIG. 4 is a chart showing the data structure of the second information 52. The second information 52 has, e.g., an antenna ratio column 521 and a position column 522. The antenna ratios extracted from the layout data 45 are recorded in the antenna ratio column 521. The coordinate positions of layout elements on the layout pattern are recorded in the position column 522. Referring to the second information 52, it is understood that a layout element of an antenna ratio AR113 is placed in a coordinate position (X113, Y113) and that a layout element of an antenna ratio AR116 is placed in a coordinate position (X116, Y116). Although the AR113, AR116, X113, Y113, X116, and Y116 are symbols in this figure, specific numerical values are recorded in reality.

Because of not including information about schematic elements, the second information 52 cannot be used, as it is, as information for visualizing the antenna ratios on a schematic diagram. In order to visualize them on a schematic diagram, information about schematic elements is obtained using a function of the data base 49. As above, the data base 49 does not have a function to directly associate correspondence information between coordinate positions on the layout pattern and the identifiers of layout elements (first correspondence information) with correspondence information between the identifiers of the layout elements and the identifiers of schematic elements (second correspondence information). For that reason, it is necessary to associate coordinate positions on the layout pattern with the identifiers of layout elements and then with the identifiers of schematic elements stepwise.

For example, the first creating unit 24, second creating unit 25, and third creating unit 26 are functionally realized in the control unit 20 by executing the PID-BA program 50.

The first creating unit 24 inquires of the data base 49 the identifiers of layout elements corresponding to coordinate positions on the layout pattern to obtain a response to that as shown in FIG. 3. That is, the first creating unit 24 creates third information 53 referring to the data base 49. The third information 53 is information in which positions on the layout pattern are associated with the identifiers of layout elements as shown in FIG. 5. FIG. 5 is a chart showing the data structure of the third information 53. The third information 53 has, e.g., a position column 531 and a layout-element identifier column 532. The coordinate positions of layout elements on the layout pattern are recorded in the position column 531. The identifiers of layout elements (e.g., layout element names) are recorded in the layout-element identifier column 532. Referring to the third information 53, it is understood that a layout element M113 is placed in a coordinate position (X113, Y113) and that a layout element M116 is placed in a coordinate position (X116, Y116).

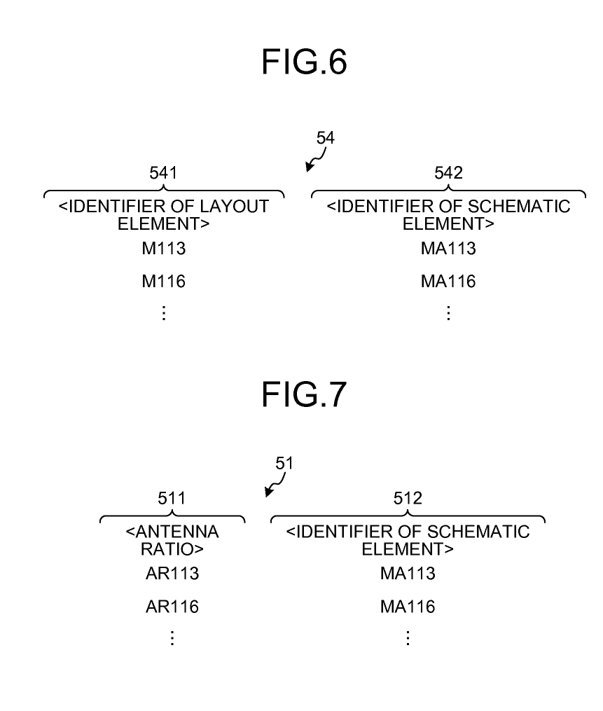

The second creating unit 25 inquires of the data base 49 the identifiers of schematic elements corresponding to the identifiers of layout elements to obtain a response to that as shown in FIG. 3. That is, the second creating unit 25 creates fourth information 54 referring to the data base 49. The fourth information 54 is information in which the identifiers of layout elements are associated with the identifiers of schematic elements as shown in FIG. 6. FIG. 6 is a chart showing the data structure of the fourth information 54. The fourth information 54 has, e.g., a layout-element identifier column 541 and a schematic-element identifier column 542. The identifiers of layout elements (e.g., layout element names) are recorded in the layout-element identifier column 541. The identifiers of schematic elements (e.g., schematic element names) are recorded in the schematic-element identifier column 542. Referring to the fourth information 54, it is understood that the layout element M113 corresponds to a schematic element MA113 and that the layout element M116 corresponds to a schematic element MA116.

The third creating unit 26 receives the second information 52 from the layout verifying unit 23, the third information 53 from the first creating unit 24, and the fourth information 54 from the second creating unit 25 as shown in FIG. 3. The third creating unit 26 creates first information 51 based on the second information 52, third information 53, and fourth information 54. The first information 51 is information in which the antenna ratios are associated with the identifiers of schematic elements. The third creating unit 26 identifies correspondence between the coordinate positions on the layout pattern and the identifiers of schematic elements respectively for the coordinate positions on the layout pattern from the third information 53 and fourth information 54, for example. The third creating unit 26 converts the second information 52 into the first information 51 using the identified correspondence.

It should be noted that, if for one schematic element multiple layout elements are laid out, multiple coordinate positions on the layout pattern correspond to the identifier of the one schematic element. In this case, one whose antenna ratio is the largest of the multiple coordinate positions on the layout pattern is selected, and using correspondence in which the selected one is associated with the identifier of the schematic element, the second information 52 can be converted into the first information 51.

The first information 51 is information in which the antenna ratios are associated with the identifiers of schematic elements as shown in FIG. 7. FIG. 7 is a chart showing the data structure of the first information 51. The first information 51 has, e.g., an antenna ratio column 511 and a schematic-element identifier column 512. The numerical values of antenna ratios extracted from the layout data 45 are recorded in the antenna ratio column 511. The identifiers of schematic elements (e.g., schematic element names) are recorded in the schematic-element identifier column 512. Referring to the first information 51, it is understood that the schematic element MA113 has the antenna ratio AR113 and that the schematic element MA116 has the antenna ratio AR116.

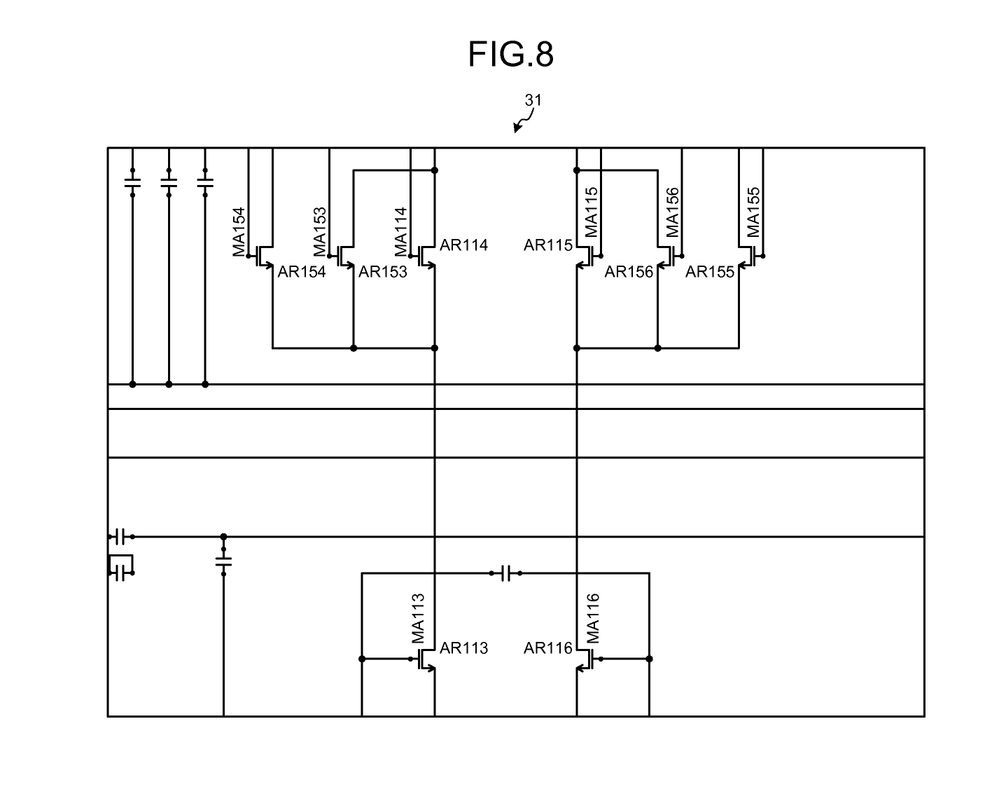

The display control unit 27 is functionally realized in the control unit 20 by executing firmware. The display control unit 27 reads the schematic data 44 from the storage unit 40 and receives the first information 51 from the third creating unit 26 as shown in FIG. 3. The display control unit 27 creates display information 31 based on the schematic data 44 and the first information 51 to display on the display unit 30. The display information 31 includes a schematic diagram in which the symbols of schematic elements are associated with respective information about the antenna ratios for the schematic elements respectively as shown in FIG. 8. For example, the antenna ratio AR113 of the schematic element MA113 is displayed near the symbol of the schematic element MA113. The antenna ratio AR116 of the schematic element MA116 is displayed near the symbol of the schematic element MA116.

A user who peruses such a schematic diagram as is shown in FIG. 8 can realize antenna ratios on the schematic diagram. Thus, the user easily realizes which layout elements are in differential-pair relation and to what degree pair symmetry deviates by seeing the layout pattern referring to the schematic diagram.

For example, in the case shown in FIG. 8, the schematic elements MA113 and MA116 are in differential-pair relation, and to what degree pair symmetry deviates can be realized by comparing the values of the antenna ratios AR113 and AR116 of the two. For example, for deviation in pair symmetry of the antenna ratios AR113 and AR116 of the schematic elements MA113 and MA116, (negative side antenna ratio)/(positive side antenna ratio)=AR116/AR113 can be used as an evaluation index. If AR116/AR113 exceeds a permissible range, then the shapes of lines connected to the schematic elements MA113 and MA116 on the layout pattern are changed via the layout editor 42 so that these antenna ratios can be corrected to coincide. Or the dimensions of transistors corresponding to the schematic elements MA113 and MA116 on the layout pattern are changed via the layout editor 42 so that variation resistance can be raised (they become less likely to vary). Thus, deviation in pair symmetry can be made to fall within the permissible range.

Which layout elements are of high importance can be realized by seeing the layout pattern referring to the schematic diagram. Thus, which layout elements on the layout pattern are to be redesigned so that the characteristics of the analog circuit satisfy required specifications can be easily identified.

For example, consider the case where it can be understood that schematic elements MA114, MA115 are higher in the degree of importance than the schematic elements MA113, MA116 by referring to the schematic diagram shown in FIG. 8. In this case, a threshold ARth1 for the antenna ratios AR114, AR115 of the schematic elements MA114, MA115 can be set severer than a threshold ARth2 for the antenna ratios AR113, AR116 of the schematic elements MA113, MA116. Thus, it can be identified that, even if the values of the antenna ratios AR114, AR115 and the values of the antenna ratios AR113, AR116 are of the same order, the characteristics of the entire circuit can be efficiently made to be close to required specifications by redesigning layout elements corresponding to the schematic elements MA114, MA115 on the layout pattern as long as:
AR114>ARth1,
AR115>ARth1,
AR113<ARth2, and
AR116<ARth2.

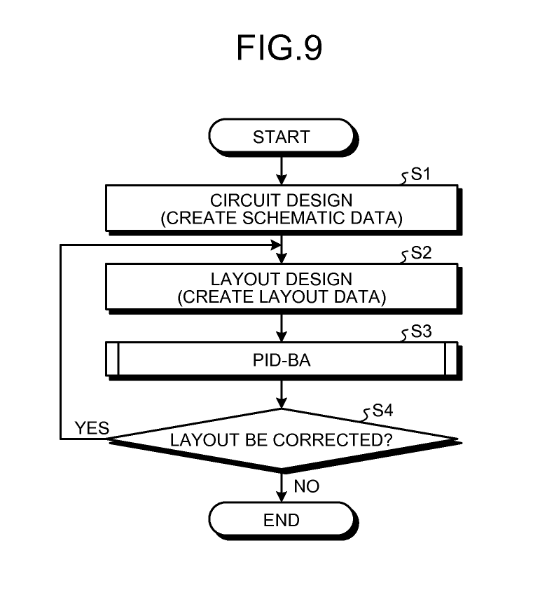

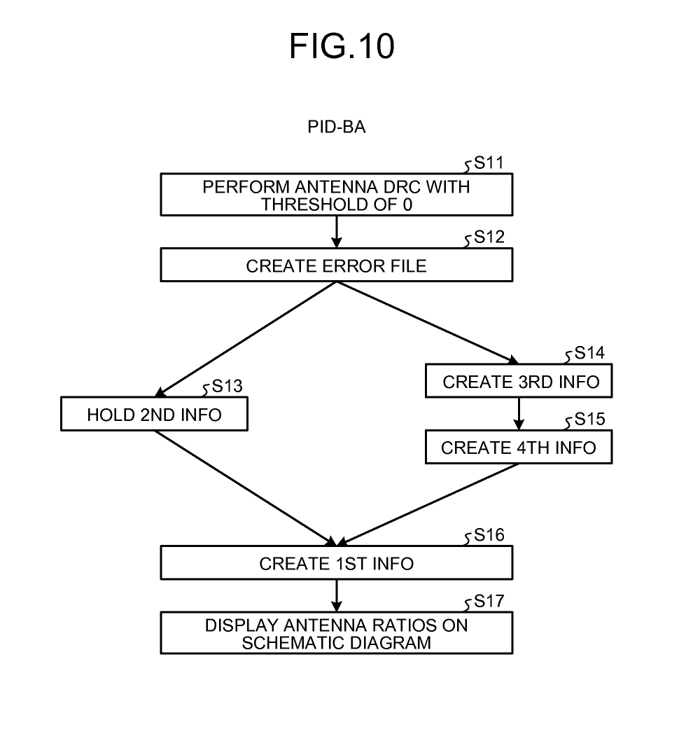

Next, a design method of a semiconductor integrated circuit using the display apparatus 1 will be described using FIGS. 9 and 10. FIG. 9 is a flow chart showing the design method of a semiconductor integrated circuit using the display apparatus 1. FIG. 10 is a flow chart showing the PID-BA process.

The display apparatus 1 executes the schematic editor 41 to perform circuit design (S1). For example, the display apparatus 1 calls out the symbols of schematic elements from a predetermined library and places them on a schematic diagram to create schematic data 44. The display apparatus 1 stores the schematic data 44 into the storage unit 40.

The display apparatus 1 executes the layout editor 42 to perform layout design (S2). For example, the display apparatus 1 places objects of layout elements on a layout pattern according to the schematic data 44 to create layout data 45. The display apparatus 1 stores the layout data 45 into the storage unit 40.

The display apparatus 1 executes the PID-BA process (S3) to visualize antenna ratios on the schematic diagram.

In the PID-BA process (S3), the display apparatus 1 sets a threshold of “0” in the verification tool 43 and performs an antenna design rule check by the verification tool 43 (S11). The display apparatus 1 creates an error file of the antenna design rule check by the verification tool 43 (S12) and holds the error file as the second information 52, in which the antenna ratios are associated with positions on the layout pattern (S13).

The display apparatus 1 verifies to what degree the layout data 45 and the schematic data 44 coincide to create a data base 49 concerning the verifying results, by the verification tool 43. The display apparatus 1 refers to the data base 49 to create the third information 53, in which positions on the layout pattern are associated with the identifiers of layout elements (S14). The display apparatus 1 refers to the data base 49 to create the fourth information 54, in which the identifiers of layout elements are associated with the identifiers of schematic elements (S15). The display apparatus 1 creates the first information 51 based on the second information 52, third information 53, and fourth information 54 (S16). The display apparatus 1 displays on the display unit 30 the schematic diagram in which the symbols of schematic elements are associated with information about the antenna ratios based on the first information 51 (S17).

When the PID-BA process (S3) finishes, it is determined whether correction (redesign) is necessary for layout elements corresponding to the schematic elements according to the antenna ratios displayed in association with the schematic elements by the display apparatus 1 on the display unit 30 (S4). If correction (redesign) is necessary for layout elements (Yes at S4), the process returns to S2, and, if correction (redesign) is unnecessary for the layout elements (No at S4), the process finishes.

As described above, in the embodiment, the display apparatus 1 creates the first information 51, in which the antenna ratios are associated with the identifiers of schematic elements, and displays on the display unit 30 the schematic diagram in which the symbols of schematic elements are associated with information about the antenna ratios based on the first information 51. Thus, which layout elements on the layout pattern are to be redesigned so that the characteristics of the analog circuit satisfy required specifications can be easily identified, so that the redesign of the layout pattern can be made efficient.

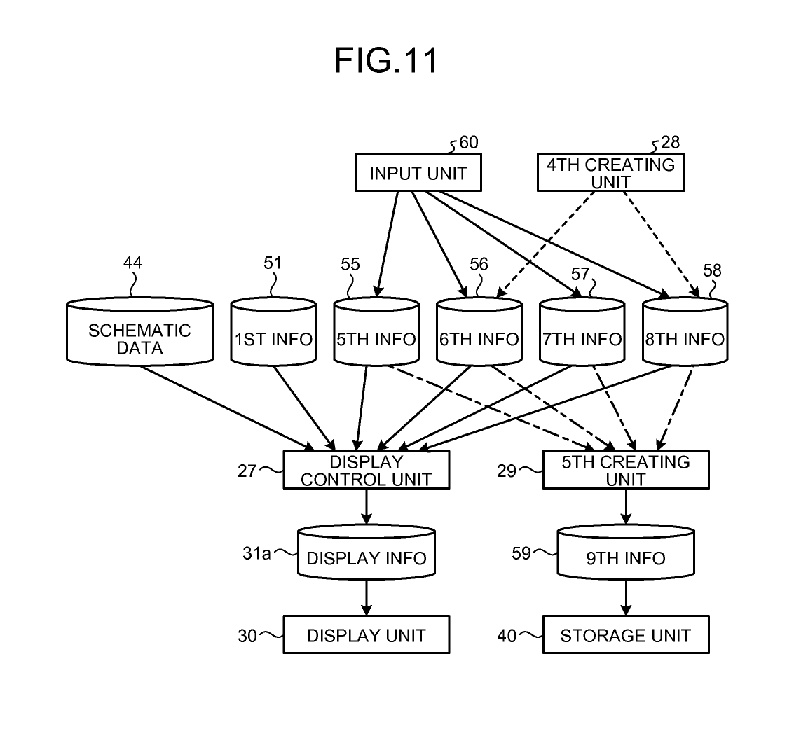

It should be noted that transistors for which pair symmetry is needed may be inputted to the display apparatus 1 beforehand, and transistors whose antenna ratios deviate may be automatically extracted based on that setting to display warning information. For example, as shown in FIG. 11, fifth information 55, sixth information 56, seventh information 57, and eighth information 58 are inputted by a user to the input unit 60 (see FIG. 2) before the PID-BA process is executed.

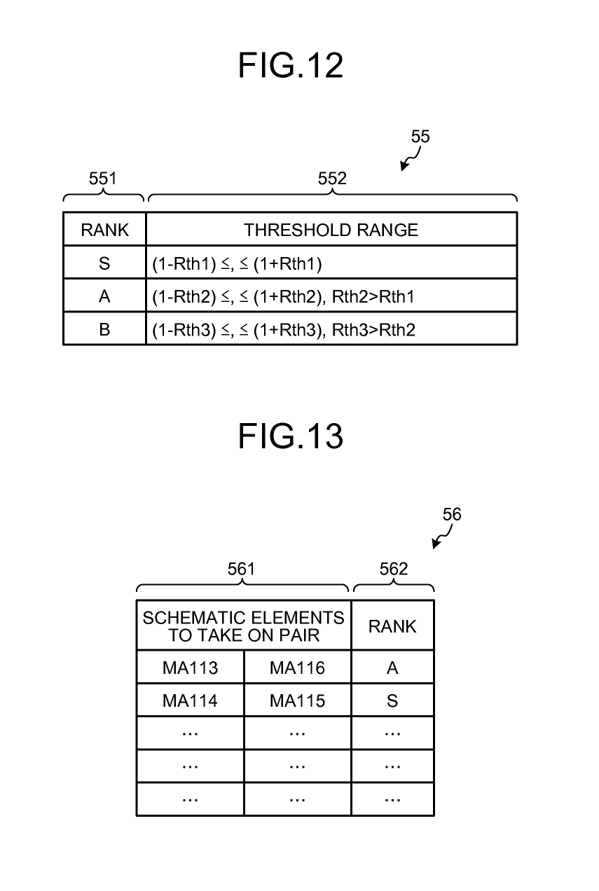

The fifth information 55 is information in which ranks are associated with threshold ranges of pair symmetry as shown in FIG. 12. FIG. 12 is a chart showing the data structure of the fifth information 55. The fifth information 55 has, e.g., a rank column 551 and a threshold range column 552. The degree-of-importance ranks of schematic elements are recorded in the rank column 551. Threshold ranges for the evaluation index of pair symmetry (=(negative side antenna ratio)/(positive side antenna ratio)) are recorded in the threshold range column 552. Referring to the fifth information 55, it is understood that, for schematic elements of rank S, the threshold range is given by 1−Rth1≦(negative side antenna ratio)/(positive side antenna ratio)≦1+Rth1. It is understood that, for schematic elements of rank A, lower than rank S, the threshold range is given by 1−Rth2≦(negative side antenna ratio)/(positive side antenna ratio)≦1+Rth2, where Rth2>Rth1. It is understood that, for schematic elements of rank B, lower than rank A, the threshold range is given by 1−Rth3≦(negative side antenna ratio)/(positive side antenna ratio)≦1+Rth3, where Rth3>Rth2.

The sixth information 56 is information in which the identifiers of pairs of schematic elements to take on pair symmetry are associated with ranks as shown in FIG. 13. FIG. 13 is a chart showing the data structure of the sixth information 56. The sixth information 56 has, e.g., a schematic element-to-take-on pair symmetry column 561 and a rank column 562. The identifiers of pairs of schematic elements to take on pair symmetry are recorded in the schematic element-to-take-on pair symmetry column 561. The degree-of-importance ranks of schematic elements are recorded in the rank column 562. Referring to the sixth information 56, it is understood that a pair of schematic elements MA113, MA116 has importance of rank A and that a pair of schematic elements MA114, MA115 has importance of rank S.

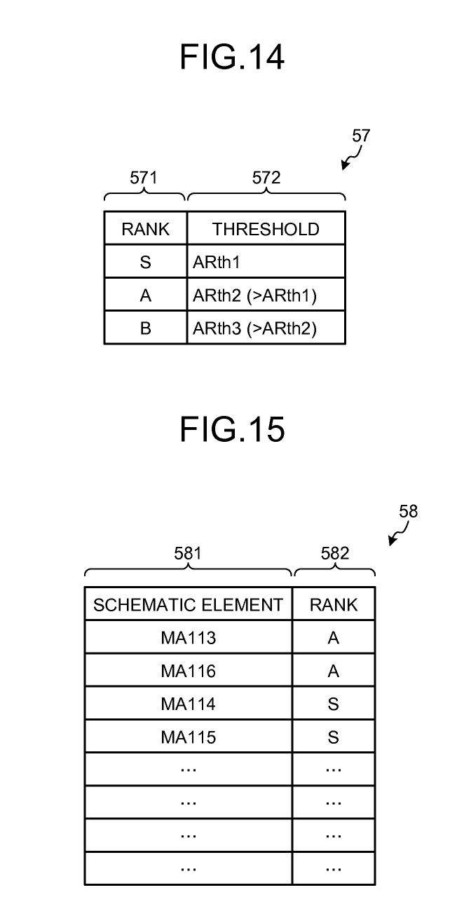

The seventh information 57 is information in which ranks are associated with antenna ratio thresholds as shown in FIG. 14. FIG. 14 is a chart showing the data structure of the seventh information 57. The seventh information 57 has, e.g., a rank column 571 and a threshold column 572. The degree-of-importance ranks of schematic elements are recorded in the rank column 571. Antenna ratio thresholds are recorded in the threshold column 572. Referring to the seventh information 57, it is understood that the threshold of schematic elements of rank S is ARth1, that the threshold of schematic elements of rank A is ARth2 (>ARth1), and that the threshold of schematic elements of rank B is ARth3 (>ARth2).

The eighth information 58 is information in which the identifiers of schematic elements are associated with ranks as shown in FIG. 15. FIG. 15 is a chart showing the data structure of the eighth information 58. The eighth information 58 has, e.g., a schematic element column 581 and a rank column 582. The identifiers of schematic elements are recorded in the schematic element column 581. The degree-of-importance ranks of schematic elements are recorded in the rank column 582. Referring to the eighth information 58, it is understood that the schematic elements MA113, MA116 have importance of rank A and that the schematic elements MA114, MA115 have importance of rank S.

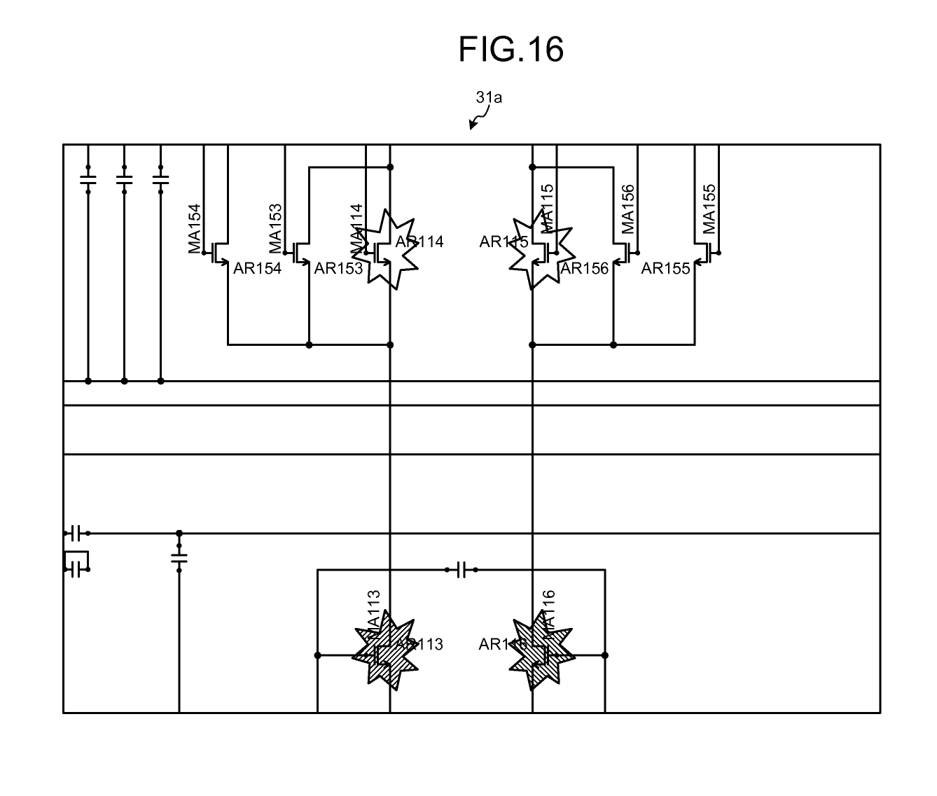

The display control unit 27 reads the schematic data 44 from the storage unit 40 and receives the first information 51 from the third creating unit 26 (see FIG. 3) and the fifth information 55, sixth information 56, seventh information 57, and eighth information 58 from the input unit 60 as shown in FIG. 11. The display control unit 27 creates display information 31a based on the schematic data 44 and the first information 51, fifth information 55, sixth information 56, seventh information 57, and eighth information 58 to display on the display unit 30. The display information 31a includes a schematic diagram in which the symbols of schematic elements are associated with information about antenna ratios for the schematic elements respectively as shown in FIG. 16. Further, the display information 31a includes a schematic diagram in which the symbols of a pair of schematic elements are associated with first warning information indicating pair symmetry exceeding the threshold range according to the rank. The display information 31a includes a schematic diagram in which the symbol of a schematic element is associated with second warning information indicating the antenna ratio exceeding the threshold according to the rank.

For example, if ‘AR116/AR113<1−Rth1’ or ‘1+Rth1<AR116/AR113’, then the symbols of the pair of schematic elements MA113, MA116 are made to blink in a first color as the first warning information. Thus, it can be easily realized that the pair symmetry of the pair of schematic elements MA113, MA116 exceeds the threshold range according to the rank. Instead of making them blink in the first color, the color of the symbols of the pair of schematic elements MA113, MA116 may be changed to a third color different from that of the other symbols as the first warning information.

For example, if:
AR114>ARth1,
AR115>ARth1,
AR113<ARth2, and
AR116<ARth2,
   then the symbols of schematic elements MA114, MA115 are made to blink in a second color as the second warning information. Thus, it can be easily realized that the antenna ratios of schematic elements MA114, MA115 exceed the threshold according to the rank. Instead of making them blink in the second color, the color of the symbols of schematic elements MA114, MA115 may be changed to a fourth color different from that of the other symbols as the second warning information.

Alternatively, the sixth information 56 and the eighth information 58 may be created by a fourth creating unit 28 as indicated by broken-line arrows in FIG. 11. The fourth creating unit 28 is functionally realized in the control unit 20 by executing a sensitivity analysis simulator 46. By executing the sensitivity analysis simulator 46, for each schematic element included in the circuit, the degree of contribution to the output of the entire circuit can be estimated. Thus, the fourth creating unit 28 performs a sensitivity analysis simulation using the schematic data 44 and, for each schematic element included in the circuit, can assign a rank of importance to the element according to the simulation results so as to create the sixth information 56 and the eighth information 58. In this case, only the fifth information 55 and seventh information 57 need to be inputted to the input unit 60, so that the load on the user can be reduced.

Alternatively, the first warning information and the second warning information may be stored in the form of a log file into the storage unit 40 instead of being displayed on the display unit 30. For example, a fifth creating unit 29 receives the fifth information 55, sixth information 56, seventh information 57, and eighth information 58 from the input unit 60 as indicated by dot-dashed arrows in FIG. 11. The fifth creating unit 29 creates ninth information 59 based on the fifth information 55, sixth information 56, seventh information 57, and eighth information 58 to store into the storage unit 40.

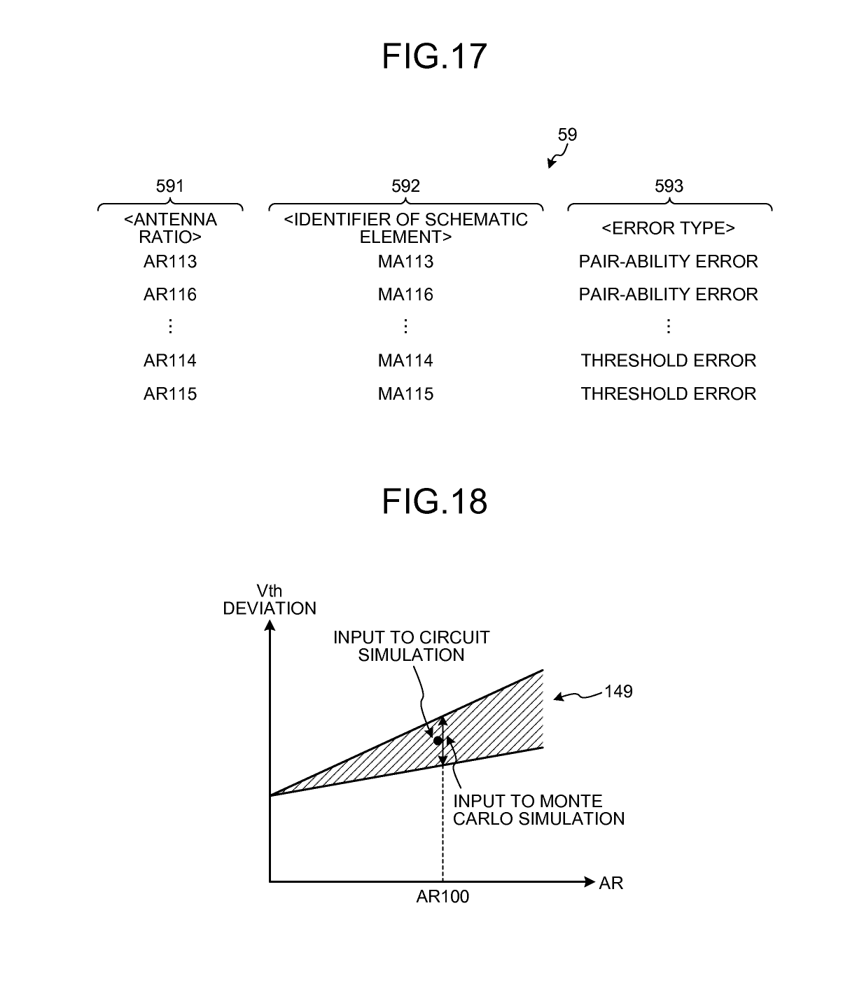

The ninth information 59 is information in which antenna ratios are associated with the identifiers of schematic elements subjected to an error, and error types as shown in FIG. 17. FIG. 17 is a chart showing the data structure of the ninth information 59. The ninth information 59 has, e.g., an antenna ratio column 591, a schematic-element identifier column 592, and an error type column 593. Antenna ratios extracted from the layout data 45 are recorded in the antenna ratio column 591. The identifiers of schematic elements (e.g., schematic element names) are recorded in the schematic-element identifier column 592. Error types (i.e., information indicating which of the first and second warning information) are recorded in the error type column 593. Referring to the ninth information 59, it is understood that the pair symmetry of the pair of schematic elements MA113, MA116 exceeds the threshold range according to the rank and that the antenna ratios of schematic elements MA114, MA115 exceed the threshold according to the rank. That is, the ninth information 59 includes the first warning information indicating pair symmetry of a pair of schematic elements exceeding the threshold range according to the rank and the second warning information indicating the antenna ratio of a schematic element exceeding the threshold according to the rank.

Alternatively, a circuit simulation and a Monte Carlo simulation may be performed based on the first information 51 created by the PID-BA process, and the amount of correction in redesigning (correcting) layout elements may be estimated. For example, the antenna ratios of all the transistors in the circuit diagram can be extracted by the PID-BA process. Meanwhile, there is correspondence between the antenna ratios of the transistors and deviations of their threshold voltages Vth as shown in FIG. 18. A correspondence area 149 shown in FIG. 18 can be acquired experimentally beforehand and stored in the form of a function or table in the storage unit 40.

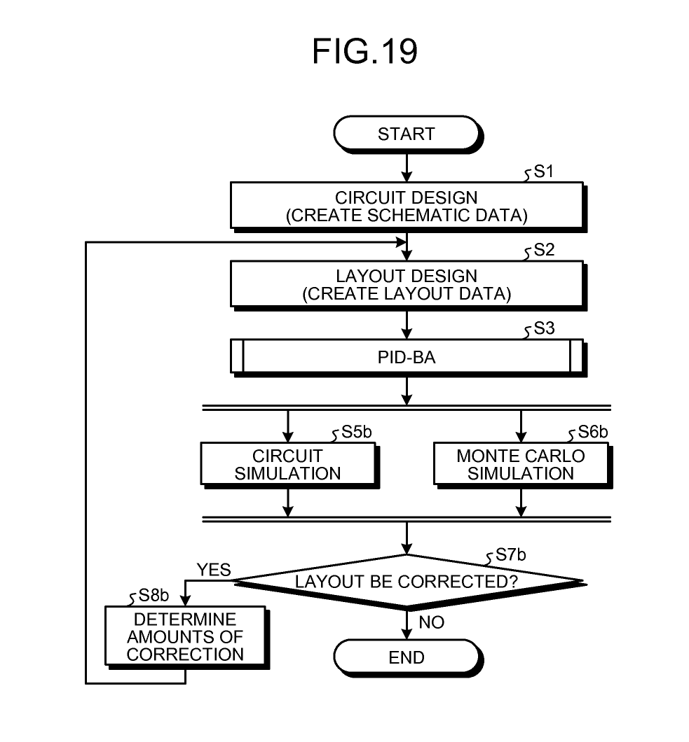

For example, as shown in FIG. 19, if the antenna ratio AR100 of a predetermined transistor is obtained through the PID-BA process (S3), the display apparatus 1 inputs the center value (Vth deviation value) of the correspondence area 149 at the antenna ratio AR100 to a circuit simulator 47 (see FIG. 2) and inputs the width (Vth variation value) of the correspondence area 149 at the antenna ratio AR100 to a Monte Carlo simulator 48 (see FIG. 2) to perform the simulations (S5b, S6b). Thus, the display apparatus 1 can determine whether the performance of the entire circuit meets required specifications according to the simulation results (S7b). If the performance of the entire circuit deviates from the required specifications, the display apparatus 1 judges that the layout needs correction (Yes at S7b) and determines the amounts of correction for layout elements according to the amount of deviation of the performance of the entire circuit from the required specifications shown in the simulation results (S8b). In this way, through the circuit simulation and the Monte Carlo simulation, the performance of the entire circuit can be quantified according to the antenna ratios, so that the amounts of correction for layout elements can be estimated, and hence the redesigning of the layout pattern can be made further efficient.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
a display unit; and
a display control unit that displays on the display unit a schematic diagram in which symbols of schematic elements are associated with respective information about antenna ratios of the schematic elements based on first information in which the antenna ratios related to plasma damage are associated with identifiers of the schematic elements.

2. The display apparatus according to claim 1, further comprising:
a layout verifying unit that verifies to what degree layout data and schematic data of a semiconductor integrated circuit coincide to create a data base concerning verifying results and extracts antenna ratios from the layout data to create second information in which the antenna ratios are associated with positions on a layout pattern;
a first creating unit that, referring to the data base, creates third information in which positions on the layout pattern are associated with identifiers of layout elements;
a second creating unit that, referring to the data base, creates fourth information in which the identifiers of the layout elements are associated with the identifiers of the schematic elements; and
a third creating unit that creates the first information, based on the second information, the third information, and the fourth information.

3. The display apparatus according to claim 2, wherein
the layout verifying unit performs an antenna design rule check with a threshold of 0 being set to create the second information.

4. The display apparatus according to claim 1, wherein
the display control unit creates display information including a schematic diagram in which symbols of the schematic elements are associated with respective information about the antenna ratios of the schematic elements, based on the schematic data and the first information to display on the display unit.

5. The display apparatus according to claim 1, wherein
the display control unit displays on the display unit a schematic diagram in which the symbols of a pair of schematic elements are associated with first warning information indicating pair symmetry exceeding threshold range according to rank, based on the first information, fifth information in which ranks are associated with threshold ranges of pair symmetry, and sixth information in which identifiers of pairs of schematic elements to take on pair symmetry are associated with ranks.

6. The display apparatus according to claim 1, wherein
the display control unit displays on the display unit a schematic diagram in which the symbol of a schematic element is associated with second warning information indicating the antenna ratio exceeding threshold according to rank based on the first information, seventh information in which ranks are associated with antenna ratio thresholds, and eighth information in which the identifiers of schematic elements are associated with ranks.

7. The display apparatus according to claim 5, wherein
the first warning information includes making the symbols of a pair of schematic elements whose pair symmetry exceeds the threshold range according to the rank blink in a first color.

8. The display apparatus according to claim 6, wherein
the second warning information includes making the symbol of a schematic element whose antenna ratio exceeds
the threshold according to the rank blink in a second color.

9. The display apparatus according to claim 5, wherein
the first warning information includes changing color of the symbols of a pair of schematic elements whose pair symmetry exceeds the threshold range according to the rank from a first color to a third color, maintaining the color of the symbols of the other schematic elements to be the first color.

10. The display apparatus according to claim 6, wherein
the second warning information includes changing color of the symbol of a schematic element whose antenna ratio exceeds the threshold according to the rank from a second color to a fourth color, maintaining the color of the symbols of the other schematic elements to be the second color.

11. The display apparatus according to claim 5, further comprising:
an input unit that receives the fifth information; and
a fourth creating unit that performs a sensitivity analysis simulation using schematic data and creates the sixth information according to simulation results.

12. The display apparatus according to claim 6, further comprising:
an input unit that receives the seventh information; and
a fourth creating unit that performs a sensitivity analysis simulation using schematic data and creates the eighth information according to simulation results.

13. The display apparatus according to claim 1, further comprising:
a fifth creating unit that creates, based on fifth information in which ranks are associated with threshold ranges of pair symmetry and sixth information in which identifiers of pairs of schematic elements to take on pair symmetry are associated with ranks, first warning information indicating the pair symmetry of a pair of schematic elements exceeding the threshold range according to the rank; and
a storage unit that stores the created first warning information.

14. The display apparatus according to claim 1, further comprising:
a fifth creating unit that creates, based on seventh information in which ranks are associated with antenna ratio thresholds and eighth information in which the identifiers of schematic elements are associated with ranks, second warning information indicating the antenna ratio of a schematic element exceeding the threshold according to the rank; and
a storage unit that stores the created first warning information.

15. The display apparatus according to claim 1, further comprising:
a fifth creating unit that creates, based on fifth information in which ranks are associated with threshold ranges of pair symmetry, sixth information in which identifiers of pairs of schematic elements to take on pair symmetry are associated with ranks, seventh information in which ranks are associated with antenna ratio thresholds, and eighth information in which the identifiers of schematic elements are associated with ranks, ninth information in which antenna ratios are associated with the identifiers of schematic elements subjected to an error, and error types; and
a storage unit that stores the created ninth information.

16. A design method of a semiconductor integrated circuit, comprising:
verifying to what degree layout data and schematic data of a semiconductor integrated circuit coincide to create a data base concerning verifying results;
extracting antenna ratios from the layout data to create second information in which the antenna ratios related to plasma damage are associated with positions on a layout pattern;
referring to the data base, creating third information in which positions on the layout pattern are associated with identifiers of layout elements;
referring to the data base, creating fourth information in which the identifiers of the layout elements are associated with identifiers of schematic elements;
creating first information in which the antenna ratios are associated with the identifiers of the schematic elements based on the second information, the third information, and the fourth information; and
displaying on a display unit a schematic diagram in which symbols of the schematic elements are associated with respective information about antenna ratios of the schematic elements based on the first information.

17. The design method of the semiconductor integrated circuit according to claim 16, further comprising:
displaying on the display unit a schematic diagram in which the symbols of a pair of schematic elements are associated with first warning information indicating pair symmetry exceeding threshold range according to rank based on the first information, fifth information in which ranks are associated with threshold ranges of pair symmetry, and sixth information in which identifiers of pairs of schematic elements to take on pair symmetry are associated with ranks.

18. The design method of the semiconductor integrated circuit according to claim 16, further comprising:
displaying on the display unit a schematic diagram in which the symbol of a schematic element is associated with second warning information indicating the antenna ratio exceeding threshold according to rank based on the first information, seventh information in which ranks are associated with antenna ratio thresholds, and eighth information in which the identifiers of schematic elements are associated with ranks.

19. The design method of the semiconductor integrated circuit according to claim 16, further comprising:
performing a circuit simulation and a Monte Carlo simulation based on the first information.

20. The design method of the semiconductor integrated circuit according to claim 19, further comprising:
determining amounts of correction for layout elements according to results of the circuit simulation and the Monte Carlo simulation if the layout needs correction.
